(19) United States
(12) Patent Application Publication
(10) Pub. No.: US 2008/0213573 A1
(43) Pub. Date: Sep. 4, 2008

(54) Pigmented film with improved aesthetic properties

(76) Inventor: Ludovic Leplatois, Montreal (CA)

Correspondence Address: MORGAN LEWIS & BOCKIUS LLP, 1111 PENNSYLVANIA AVENUE NW, WASHINGTON, DC, 20004, US

(21) Appl. No.: 11/822,812

(22) Filed: Jul. 10, 2007

Related U.S. Application Data
(60) Provisional application No. 60/806,832, filed on Jul. 10, 2006.

(51) Int. Cl. B32B 7/02; B32B 9/00; C08K 3/00; C08K 3/20; C08K 3/26; C08K 3/30; C08K 3/34

(52) U.S. Cl. 428/332; 428/411.1; 524/570; 524/556; 524/427; 524/423; 524/451; 524/456; 524/445

(57) ABSTRACT

The present invention provides a pigmented thermoplastic film comprising one or more mineral filler agents at an amount effective to prevent or reduce the occurrence of discolouration when the film is stretched and/or to prevent or reduce the loss of the mechanical properties of the film, such as elasticity, stretchability, tear resistance, or perforation resistance. Also provided is a process and a composition for manufacture of such films. The films of the present invention are useful for industrial packaging, especially with automatic wrapping machines, but may be used to wrap any product for shipping or storage.

### CROSS REFERENCE TO RELATED APPLICATIONS

This application claims priority to U.S. Provisional Application No. 60/806,832 filed Jul. 10, 2006, all of which is incorporated herein by reference in its entirety.

### FIELD OF THE INVENTION

The present invention pertains to the field of thermoplastic films and more particularly, to the field of thermoplastic films comprising a mineral filler agent.

### BACKGROUND

Stretch plastic film, commonly referred to as a stretch hood or bag, has gained substantial acceptance for use in the lumber industry and in warehouse packaging applications where plastic film is stretched around pallets, containers or irregular loads, with built-in elastic recovery properties of the film constraining the surrounding item(s). A number of plastic materials, such as polyvinyl chloride (PVC), linear low-density polyethylene (LLDPE), low density polyethylene (LDPE), and ethylene vinyl acetate copolymers (EVA), low density polyethylene (LDPE), polyolefin plastomers (POP) are used to produce stretch film for commercial use.

With the emergence of automatic stretching machines and new elastomeric films, packaging operations have changed the manner in which materials are packaged. Many of these industries have switched from manual wrapping to automated wrapping. Automated wrapping machines are used to wrap many different materials, for example lumber, OSB panels, stud bundles, gypsum boards, insulation panels, bricks, appliances, pallets of shipping bags or cardboard boxes and the like, all of which are typically placed on pallets prior to the wrapping process. The wrapping is completed by first forming a bag or cylinder of the elastomeric film that is then stretched over or around the material to be retained.

Non-stretch plastic films are also routinely used for wrapping materials and for manufacture of bags, or the like, for packaging material.

Films used in wrapping or packaging are often pigmented on one or both sides in order to protect the packaged material from exposure to light. A drawback of automatic wrapping processes is that the wrapping material tends to be overstretched in different areas of the final wrapped product. Local overstretching of films results in generation of “stretch marks”, or areas in which the film is permanently deformed. This problem is exaggerated in pigmented films since the region of permanent deformation is thinner than the non-deformed areas of the film and, as a result, there is a corresponding discolouration. For example, if the film contains a white pigment on an outer layer and a black pigment on the inner layer, an overstretched area appears grey instead of white. This discoloured overstretched area is relatively thin and, although the film retains its qualities, the discolouration gives a sense of poor quality in the appearance of the final wrapped product.

Mineral agents, such as calcium carbonate, talc, silica, calcium sulfate, wollastonite, glass fiber, have been used as fillers in plastic films. Calcium carbonate has gained relatively widespread acceptance as a mineral reinforcement agent for achieving improved film processing and for modifying film properties (See, for example, Ruiz, F. A., “Modifying Film Conversion and End-Use Characteristics with Mineral Reinforcement,” 1996 Polymers, Laminations & Coatings Conference Proceedings; Ruiz, F. A., “Mineral Reinforcement of Metallocene-Catalyzed LLDPE Film and Bags,” 2000 TAPPI Polymers, Laminations, & Coatings Conference; and Ruiz, F. A. “Film Physical Property Effects of Low-Level Calcium Carbonate Addition to LLDPE,” 2004 PLACE Conference). It has been previously observed that the use of mineral filler agents, such as calcium carbonate, talc, silica, as anti-blocking agents make films less elastic even at low concentrations. Calcium carbonate has also long been used to make thin plastic films stiffer with better tensile properties.

U.S. Pat. No. 5,922,800 discloses a specific blend of LLDPE and calcium carbonate that is used to produce films with good film impact properties which are sustained over time, without an observed reduction in modulus or stiffness.

U.S. Pat. No. 6,703,439 discloses a polyolefin resin composition, and polyolefin film prepared therefrom, which contains 30 to 75 percent by weight of an inorganic filler. The disclosed polyolefin film is used to prepare a porous polyolefin film by stretching the film directly produced from the resin composition. The presence of the inorganic filler results in the generation of micro-voids, which, upon stretching of the film, become pores in the film.

In another specific example of the use of mineral fillers, U.S. Patent Application No. 20040087235 discloses a two layer elastomeric film in which the first layer optionally includes filler particles. In the disclosed film the filler particles are typically used to reduce the costs associated with producing elastomeric films since a lesser amount of copolymer was utilized. The resulting films were, however, microporous. In particular, the films disclosed in U.S. Patent Application No. 20040087235, which include filler particles, included a plurality of voids within the matrix surrounded by relatively thin microporous membranes defining tortuous paths, and one or more of the filler particles in each void.

Published International PCT Application No. WO 98/29479 (Gwaltney et al.) discloses elastomeric films including metallocene catalyzed polyethylene, which are porous for use with disposable items such as diapers and other personal care products that require an absorbent. The disclosed elastomeric films comprise mineral fillers, such as calcium carbonate, for use to create “pores” in the elastomeric film.

A need remains for a pigmented film that when stretched or thinned is not marred by discolouration.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide pigmented thermoplastic film with improved aesthetic properties. In accordance with one aspect of the present invention, there is provided a thermoplastic polyolefin film comprising one or more layers wherein at least one layer comprises a mineral filler agent in an amount sufficient to mask a stretch mark. In accordance with one embodiment of the present invention, the film comprises at least one layer containing from about 0.5% to about 30% by weight of a mineral filler agent. In accordance with a more particular embodiment of the present invention the at least one layer of the film comprises from about 0.5 to about 15% by weight of a mineral filler agent. A specific example of a mineral filler agent suitable for use in the present invention is calcium carbonate.

In accordance with another aspect of the present invention, there is provided a use of a mineral filler agent to mask stretch marks in a pigmented thermoplastic polyolefin film, wherein the mineral filler agent is included in one or more layers of the pigmented film at an amount of from about 0.5% to about 30% by weight.

In accordance with another aspect of the present invention, there is provided a method for manufacturing a pigmented thermoplastic polyolefin film comprising providing a composition for at least one layer of the pigmented film, which composition comprises from about 0.5% to about 30% by weight of a mineral filler agent.

### BRIEF DESCRIPTION OF THE FIGURES

Further features and advantages of the present invention will become apparent from the following detailed description, taken in combination with the appended drawings, in which:

FIG. 1 is a photograph of a wood bundle packaged with a standard elastomeric film and exhibiting stretch marks (indicated by arrows and a dashed boarder).

FIG. 2 is a photograph of a close up view of a stretch mark in a standard elastomeric film used to package a wood bundle (the stretch mark is indicated by an arrow).

FIG. 3 is a photograph of a close up view of a stretch mark in a pigmented, elastomeric film according to one embodiment of the present invention, which was used to package a wood bundle.

FIG. 4 is a photograph of a wood bundle packaged with a pigmented, elastomeric film according to one embodiment of the present invention.

FIG. 5 is a photograph of a close up view of a stretch mark in a pigmented, elastomeric film according to one embodiment of the present invention, which was used to package a wood bundle.

FIG. 6 is a graph depicting the procedure of a stretchability test on the elastomeric films containing mineral filler agents of the present invention.

FIG. 7 is a graph depicting the procedure of a retention stress test on the elastomeric films containing mineral filler agents of the present invention.

### DETAILED DESCRIPTION OF THE INVENTION

The present invention provides a pigmented thermoplastic polyolefin film comprising one or more mineral filler agents. It has now been surprisingly found that the presence of a mineral filler agent in a pigmented film masks stretch marks and improves the mechanical properties, such as tear resistance of the film. In particular, it has now been surprisingly found that the addition of one or more mineral filler agent to a plastic film prevents or reduces discolouration of overstretched regions (or stretch marks) of the films, without having any detrimental effects on the integrity of the film.

The film of the present invention comprises a mineral filler agent that serves to prevent or reduce the discolouration of pigmented films when overstretched in comparison to an equivalent film that does not contain the mineral filler agent. By way of example, the pigmentation of a stretched film is maintained even when the film is stretched beyond the elastic recovery point, without compromising the film's stretchability, elastic retention, tear resistance, or puncture resistance. Thus the aesthetics of the elastomeric film even when stretched is maintained, without compromising the integrity of the film, by preventing discoloration of a pigmented film.

In accordance with one embodiment of the present invention, the film is an elastomeric film. In accordance with an alternative embodiment of the present invention the film is a non-stretch film.

In accordance with a preferred embodiment of the present invention, the film is a breathable film. The film of the present invention is non-porous. The term “porous,” as used herein, refers to films that are not continuous and include voids or perforations. Typically, voids in porous films are induced by a non-recoverable stretch process (see, for example, U.S. Pat. Nos. 4,364,985 and 5,891,376) and perforations are created by a pin or needle. The term “breathable,” as used herein, refers to films that allow passage of moisture vapour. The rate of transmission of moisture vapour is inversely proportional to the degree of tortuous path. Holes or voids will facilitate the transfer of moisture from one side to the other. Crystallites in the film make it more difficult for moisture to go through the film (they act as internal barriers). Thus, porous films are more breathable than similar non-porous films, but a non-porous film can be breathable. The films of the present invention are monolithic (i.e., continuous) and are breathable or not depending on its application. For example, films that are used to manufacture medical gowns are not breathable.

The film of the present invention comprises one or more layers and has a thickness in the range of about 1 to about 8 mil (1 mil=1 thousandths of an inch). At least one of the layer of the film comprises a mineral filler agent, which has a particle size ranging between about 0.01 and about 100 microns but preferably between about 0.01 and 10 microns and even more preferably approximately 1 micron.

### Components of the Film

In accordance with another aspect of the present invention there is provided film-forming compositions used to manufacture pigmented films having improved aesthetic properties. The film-forming compositions contain components of the individual layer(s) of the film of the present invention.

### Resins

The compositions from which the layers of the film of the present invention are manufactured, comprise one or more resin components selected from: an ethylene-vinyl acetate (EVA) copolymer; a polyolefin plastomer (POP); a high density polyethylene; a medium density polyethylene; a linear low density polyethylene (LLDPE); and a low density polyethylene (LDPE).

Selection of the appropriate resin or combination of resins is dependent on the application of the film. These properties can be varied independently. For example, a resin composition can be selected to manufacture a film having high stretchability but little or no retention force (elasticity, or elastic memory). Alternatively, a resin composition can be selected to manufacture a film having low stretchability and high elastic memory. By way of example, increasing the vinyl acetate (VA) content of the film will result in a decrease in retention force and an increase in stretch ability. The decrease in elastic memory can be offset by increasing the amount of LLDPE in the film composition. The present invention contemplates a variety of film compositions that are formulated for specific applications according to the teaching provided herein.

Various combinations of layers can be used in the formation of multilayer films according to the invention. The 3-layer embodiments described herein are provided as illustrations and are not intended to limit the scope of the invention. The multilayer films of the invention can also comprise more layers. Thus, modifications and variations may be utilised without departing from the principles and scope of the invention, as those skilled in the art will readily understand.

### Pigment

At least one layer of the film of the present invention contains a pigment. Selection of the pigment is made based, in part, on the application of the film. For example, in some instances the pigment is added as a UV protector or as heat reflective agent. In other instances, the pigment is included for aesthetic or marking purposes only. Pigments used in the film of the present invention can be natural, synthetic, inorganic, or organic. Many pigments suitable for use in plastic films are commercially available.

Pigments are often added to the resin blend in the form of concentrates (or master batches), formulated to improve dispersion of the pigment within the film.

In accordance with one embodiment of the present invention the pigment is contained in one or more layer of the film. In accordance with a specific embodiment of the present invention, the pigmented film comprises three layers in which the inside layer (i.e., the layer that comes in contact with the material to be packaged) contains a black pigment and the outside and the core layers both contain a white pigment. In an illustrative example of this embodiment the pigment composition is as follows:

Inside: 5 to 15% black masterbatch (MB), wherein the black MB contains 45% carbon black by weight;

Core: 5 to 15% white MB, wherein the white MB contains 70% Titanium Oxide by weight; and

Outside: 5 to 15% white MB, wherein the white MB contains 70% Titanium Oxide by weight.

In an alternative embodiment at least one layer of the film contains a coloured pigment (i.e., not white or black).

### Mineral Filler Agents

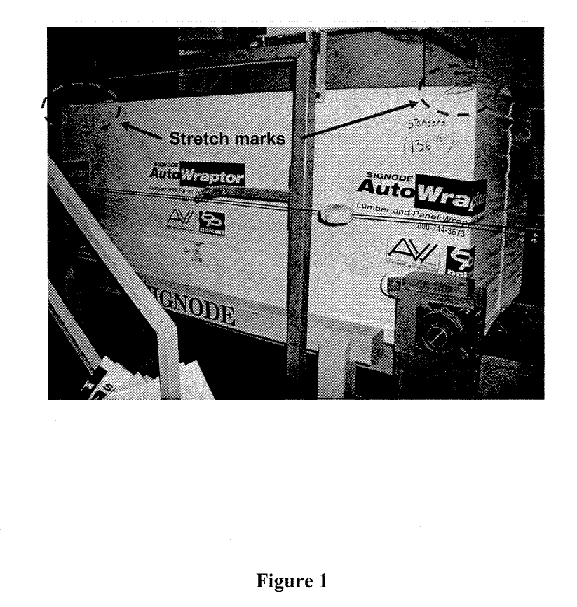

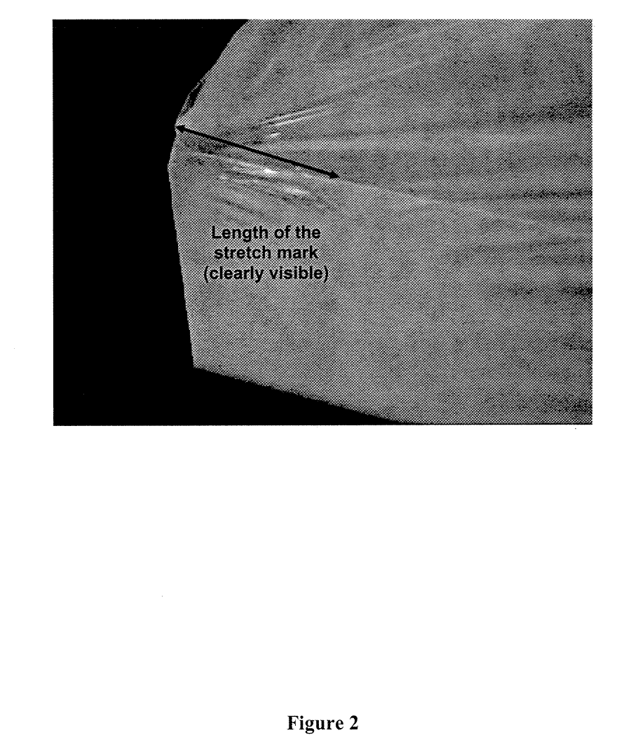

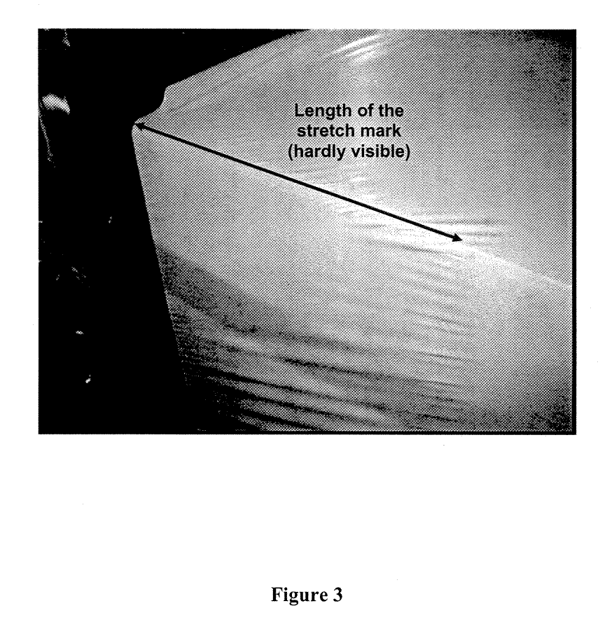

In accordance with one aspect of the present invention, a mineral filler agent is added to the film in order to decrease the appearance of stretch marks in the pigmented film by minimizing the discolouration of the film when stretched. FIGS. 1 and 2 are photographs of stretch marks in standard pigmented films. As is evident from these photographs the stretch marks are readily apparent because of the discolouration. In contrast, the photograph in FIG. 3 shows a stretch mark in a pigmented film according to one embodiment of the present invention. In this case the stretch mark is masked due to the presence of the mineral filler agent.

The at least one layer of the pigmented film of the present invention comprises mineral filler agent in an amount of about 0.5% to about 30% by weight based on the total weight of the components of the layer. Advantageously, the at least one layer of the pigmented film contains mineral filler agent in an amount of about 5% to about 30% by weight based on the total weight of the components of the layer. Selection of the specific amount of mineral filler agent used within this range is made based on the application of the film. Generally the amount of mineral filler agent employed is sufficient to provide the stretch mark masking effect while not being detrimental to the mechanical properties (e.g., elastic properties) of the film.

The material from which the mineral filler agent is prepared is not critical, provided that the agent (i) has an average or a median particle size within the defined range of 0.01 to 100 microns and (ii) is capable of appropriate dispersion within the film. A mineral filler agent that exhibits appropriate dispersion within the film is one that exhibits good mixing properties and does not spontaneously agglomerate under film processing conditions.

The size and other physical characteristics of the mineral filler material are selected to allow the film to remain stretchable without being susceptible to tearing, lensing, perforation, or reduced elasticity while at the same time not becoming stiff or brittle (i.e., comprising increased tensile strength). Selection of the appropriate mineral filler agent is made, in part, based on the colour of the pigment(s) in the film. For example, calcium carbonate is suitable for use as a mineral filler to mask stretch marks in a white or colour pigmented film.

Examples of suitable mineral filler agents include, but are not limited to calcium carbonate, calcium sulfate, talc, wollastonite, silica, clay, glass fibre and the like, which can be used alone or in combination. Within this class of mineral filler agents a sub-class of suitable mineral filler agents has a relatively narrow particle size distribution, which is advantageously between 0.01 and 10 mil, most preferably the particle size is approximately 1 micron.

In use, the mineral filler agent is usually provided in a high content master batch, comprising 10 to 80% mineral filler agent by weight. Advantageously, the mineral filler agent master batch comprises between 25 and 75% mineral filler agent by weight.

In an alternative embodiment the mineral filler agent is added directly to the resin mixture rather than in a master batch. In this case, the mineral filler agent is provided at a final concentration of about 0.5% to about 30% by weight in one or more layers of the film. Advantageously, the mineral filler agent is provided at a concentration of about 5% to about 30% by weight in one or more layers of the film.

### Additives

One or more layers of the pigmented film of the present invention can include one or more additives useful in packaging films, such as, but not limited to, a slip agent, an anti-skid agent (See, for example, International PCT Publication No. WO 2004/028800, which discloses elastomeric films comprising from 0.1 to 10% of an anti-skid additive, which anti-skid additive has a particle size between 50 and 500 microns and does not melt or has a melt temperature greater than 500° F.), an anti-static agent, an anti-fog agent, an antioxidant, a heat stabilizer; a filler, a radiation stabilizer (e.g., a UV stabilizer (inhibitor)) and/or an anti-blocking agent. Such additives, and their effective amounts, are known in the art, however, typical additive master batch loading amounts are in the range of 0.1% to 5% by weight based on the layer of the film containing the additive.

In accordance with a specific embodiment of the present invention, one or more layers of the film includes a hindered amine light stabilizer as a UV inhibitor.

In accordance with another embodiment of the present invention, one or more layers of the film includes an anti-blocking agent that is calcium carbonate, talc or silica.

In accordance with another embodiment of the present invention, one or more layers of the film includes anti-static agent that is ethoxylated amine or dodecanamide.

In accordance with another embodiment of the present invention, one or more layers of the film includes an anti-skid agent that is a polymeric or an inorganic cluster material. A suitable anti-skid additive has a particle size within the range of 50 to 500 microns. The material from which the anti-skid additive is prepared is not critical, provided that the additive (i) has a particle size within the defined range of 50 to 500 microns; (ii) either does not melt or melts at a temperature of 500° F. or greater; and (iii) is capable of appropriate dispersion within the film. An anti-skid additive that exhibits appropriate dispersion within the film is one that exhibits good mixing properties and does not spontaneously agglomerate under film processing conditions.

Examples of suitable anti-skid additives include, but are not limited to, sand, clay, silica, cross-linked polyethylene, ultra high molecular weight polyethylene (UHMWPE) or other polymers. Within this class of anti-skid additives a sub-class of suitable anti-skid additive has a relatively narrow particle size distribution, which is advantageously between 60 and 250 microns, or more specifically, between 60 and 180 microns, and a high molecular weight (usually with a melt index below 0.1 g/10 min).

In accordance with another embodiment of the present invention, one or more layers of the film includes a slip agents that is oleamide, erucamide or stereamide.

### Manufacture

The film of the present invention can be manufactured by a variety of processes known in the art, including extrusion (e.g., blown-film extrusion, coextrusion, extrusion coating, free film extrusion, and lamination), casting, and adhesive lamination. A combination of these processes can also be employed. These processes are well-known to those of skill in the art. Coextrusion manufacture can use, for example, a tubular trapped bubble film process or a flat film (i.e., cast film or slit die) process.

### Characteristics of the Pigmented Film

In addition to the improved aesthetics provided by the mineral filler agents in preventing discolouration of the pigmented films when stretched, the use of mineral filler agents in general, for example calcium carbonate (CaCO₃), can also improve key mechanical properties of the finished film, including, for example, increased tear resistance, in comparison to those of an elastomeric film that does not include a mineral filler.

The use of a mineral filler agent, such as, CaCO₃, in the films of the present invention was found to improve the machine direction (MD) tear strength and elastic retention stress while maintaining puncture resistance and stretchability. Thus, in addition to masking stretch marks in the pigmented films, the incorporation of a mineral filler agent can also provide improved mechanical performance.

In accordance with a specific embodiment of the present invention, the pigmented film is an elastomeric film. In this case, the elasticity of the film is maintained even with resins comprising a density greater than 0.88 g/ml, regardless of the catalyst used to form the film and regardless of whether the film comprises one or more additives, such as an anti-skid additive. It has now been surprisingly found that one or more mineral filler agents, for example, calcium carbonate, can be used to mask the phenomenon of discoloration upon stretching of the film without having an adverse effect on the elasticity of the pigmented elastomeric film.

The specific physical properties, including stretchability, elastic retention stress, tear strength and puncture strength, of a film of the present invention can be tailored depending on the application of the film. Alterations in the resin compositions used to manufacture the one or more layers of the film can be made in order to customize the properties of the film as appropriate based on the film's application. Such alterations are routine to workers skilled in the field.

To gain a better understanding of the invention described herein, the following examples are set forth. It should be understood that these examples are for illustrative purposes only. Therefore, they should not limit the scope of this invention in any way.

### EXAMPLES

### Example 1

### Pigmented Elastomeric Films Comprising CaCo₃

The following are two non-limiting examples of pigmented, continuous, elastomeric films according to two specific embodiments of the present invention. These films were used in a comparison with an elastomeric film that does not contain mineral filler agent. All of the films were manufactured using the film forming compositions listed below and a blown film extrusion process. The mineral filler MB included in the following formulations is a master batch containing 75% CaCO₃ mineral filler by weight. The black MB included in the following formulations is a master batch containing 45% carbon black by weight. The white MB included in the following formulations is a master batch containing 70% Titanium Oxide by weight.

### Comparative Example A of Formulation without Mineral Filler

A (15%): 100% LLDPE+15% black MB

B (70%): 100% POP+10% white MB

C (15%): 100% LLDPE+10% white MB

FIGS. 1 and 2 depict a wood bundle packaged with a film made from the formulations of Comparative Example A. As is evident from the photographs in FIGS. 1 and 2, stretch marks in a film formed from the formulation of Comparative Example A are discoloured.

### Comparative Example B of Formulation without Mineral Filler Here Above

A (15%): 100% LLDPE+15% black MB

B (70%): 70% POP+30% LLDPE+10% white MB

C (15%): 100% LLDPE+10% white MB+3% UVI MB

### Example 1A

### Formulation with Mineral Filler

A (15%): 100% LLDPE+10% mineral filler MB+15% black MB

B (70%): 100% POP+30% mineral filler MB+10% white MB

C (15%): 100% LLDPE+10% mineral filler MB+10% white MB

FIG. 3 depicts a wood bundle wrapped with film made from the formulations of Example 1A. As is evident from the photograph in FIG. 3, stretch marks in a film formed from the formulation of Example 1A are masked.

### Example 1B

### Formulation with Mineral Filler

A (15%): 100% LLDPE+12% black MB

B (70%): 70% POP+30% LLDPE+15% mineral filler MB+8% white MB

C (15%): 100% LLDPE+10% white MB

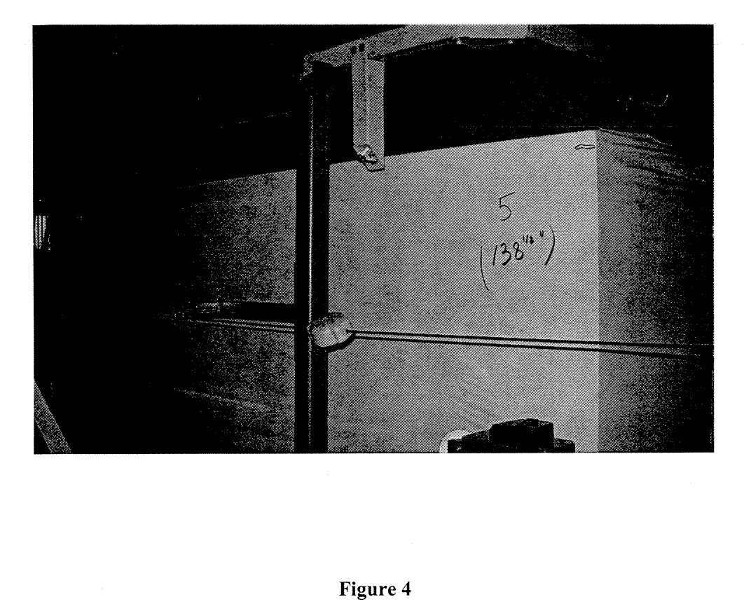

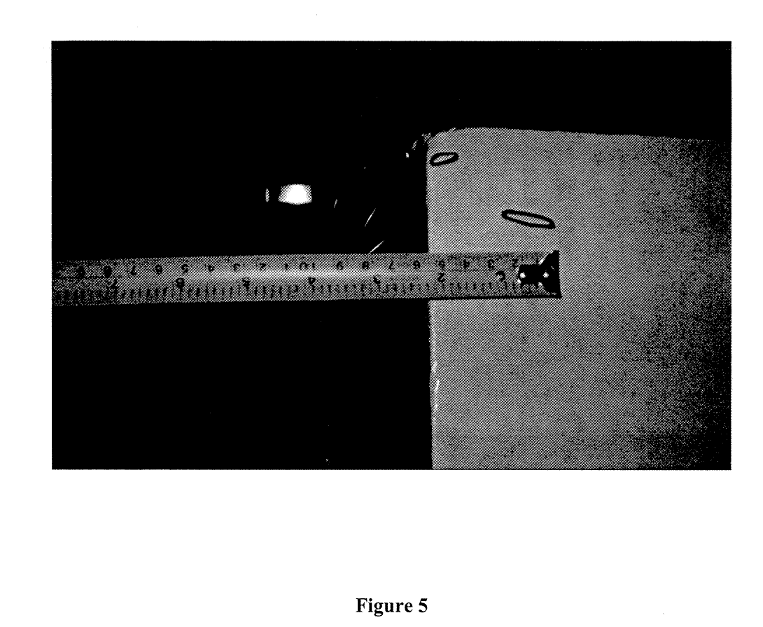

FIGS. 4 and 5 depict a wood bundle wrapped with a film made from the formulations of Example 1B. As is evident from the photographs in FIGS. 4 and 5, stretch marks in a film formed from the formulation of Example 1B are masked.

It is understood that in each of the above formulations, the layers can include additives such as those described herein. The addition of such additives and the appropriate amounts are selected based on the final application of the film and such a selection is routine in the art.

The present example also demonstrates that the use of mineral filler agents in general, for example calcium carbonate (CaCO₃), allows an improvement in key mechanical properties of the continuous elastomeric film, including increased tear resistance and elastic retention stress while maintaining stretchability and puncture resistance, as exhibited in Table 1 below.

TABLE 1

| | Comparative Example B | Example 1B |
|---|---|---|
| stretchability MD | 53.80% | 52.10% |
| stretchability TD | 51.60% | 51.10% |
| elastic retention stress TD | 481.8 | 503.3 |
| (50%/25%) | | |
| MD tear (g/mil) | 428 | 495 |
| puncture (lb · in/mil2) | 0.816 | 0.825 |

Stretchability and retention stress were measured using the methods outlined in detail below. These tests were performed to evaluate the ability of a film to be stretched and to measure the elastic retention remaining in a film after it has been stretched.

Puncture resistance was tested using lubrication between the film and the dart. Such a test is therefore, defined in the film industry as being a low friction puncture resistance evaluation to eliminate the coefficient of friction (COF) effect.

### Test Procedure for Stretchability Evaluation

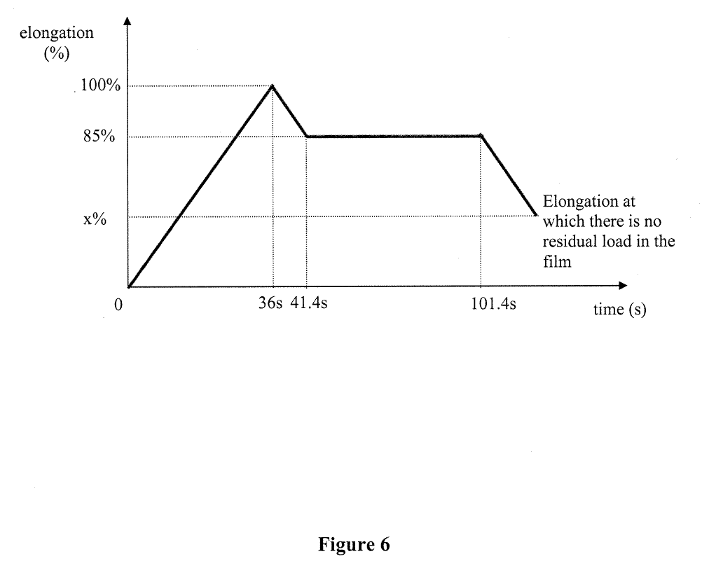

The principle of this procedure is to evaluate the ability of an elastomeric film of the present invention to be stretched. It consists in stretching a polymeric film test strip of 12 inches long by 100% and then returning the film to 85% of its stretch capacity for one minute. After this pause, the upper jaw holding the film is moved down again up to the point where there is no residual load on the film. The load is measured on the top left screen of the Instron 4411 tensile instrument. When the load falls to zero, the elongation of the film is measured. This elongation (x %), expressed in percentage of the extra remaining length over initial length of the 12″-strip, corresponds to the limit of elastic recovery of the film. This test is performed in machine direction as well as transversal direction of the film and the procedure of the test is depicted in FIG. 6. The stretchability is expressed in percentage as being %=1−x % and for elastomeric films of the present invention comprising mineral filler agents this stretchability value is greater than 50% and usually higher which is identical or superior to elastomeric films presently used in the industry.

To test the stretchability of the elastomeric films the following procedure was conducted. Three 1 inch-wide strips approximately 14 inches in length where cut in the longitudinal and transverse direction of a test film. The upper and lower ends of each test strip held in the upper and lower grips were initially separated by 12 inches. The upper grip was moved up to 100% of elongation (12 inches) and immediately brought back to 85% of elongation (10.2 inches), and the elastomeric film is stretched at 85% for 1 minute. The upper grip is moved back down to the point where there is no residual load in the film and the extra remaining length (l) of the film at which there is no residual load in the film is recoded. The stretchability value of the elastomeric film is calculated using the formula:

% stretchablilty=(12″−l)/12″.

### Description of the Test Procedure for Retention Stress Evaluation of the Elastomeric Films

The principle of this procedure is based on stress relaxation phenomenon. This procedure estimates the retention force remaining in a film after a stretching cycle. A elastomeric film test sample is mechanically stretched in its transversal direction (TD) using the INSTRON 4411 up to x % and then brought back to y %, y being lower than x. In most controls the value of x will be equal to 50 and the value of y equal to 25 and thus, the testing could be called 50%-25% retention test method.

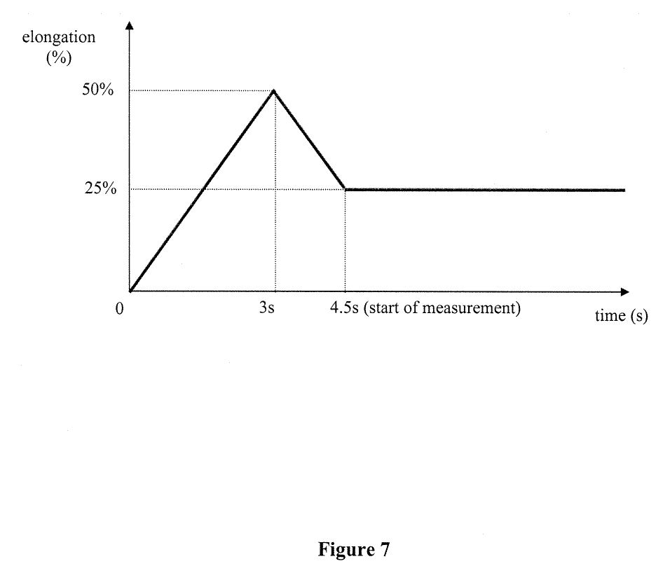

The initial distance between the two grips/jaws holding the upper and lower ends of the test strip is 2 inches. The moving velocity of the upper grip is set at the maximum value of the traction machine, being 20 inch/min. Thus, it takes 3 seconds for stretching to 50% and 1.5 seconds for returning the stretched film back to 25% elongation. This corresponds to a total stretching cycle of 4.5 seconds as illustrated in FIG. 7. Empirically after few cycles of time similar to the period of stress assumed to correspond to 10 times the period of applied stress, the material is almost totally relaxed. This is exactly what it is observed since, after 3 minutes (180 seconds), measurements are quite stable. This indicates that measuring the remaining force in the film up to 3 minutes is largely sufficient. Advised measuring time is 1, 2 and 3 minutes. For consistency, measurements should be repeated on 3 polymeric strips to be able to calculate an average measurement value.

All publications, patents and patent applications mentioned in this Specification are indicative of the level of skill of those skilled in the art to which this invention pertains and are herein incorporated by reference to the same extent as if each individual publication, patent, or patent applications was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A non-porous, pigmented thermoplastic polyolefin film comprising one or more layers, wherein at least one of the layers comprises from about 0.5% to about 30% by weight of a mineral filler agent.

2. The film according to claim 1, wherein at least one layer of said film comprises from about 0.5% to about 15% by weight of a mineral filler agent.

3. The film according to claim 1, wherein said mineral filler agent has an average or median particle size of about 0.01 microns to about 100 microns.

4. The film according to claim 1, wherein each of said one or more layers independently comprises an ethylene-vinyl acetate (EVA) copolymer, a polyolefin plastomer (POP), a high density polyethylene, a medium density polyethylene, a linear low density polyethylene (LLDPE), a low density polyethylene (LDPE) or a combination thereof.

5. The film according to claim 1, wherein the mineral filler agent is calcium carbonate, calcium sulfate, talc, wollastonite, silica, clay, glass fibre or a combination thereof.

6. The film according to claim 5, wherein the mineral filler agent is calcium carbonate.

7. The film according to claim 6, wherein the film comprises a white pigmented layer.

8. The film according to claim 1, wherein the film is elastomeric.

9. The film according to claim 1, wherein at least one of the layers comprises an anti-skid additive, an anti-static agent, an anti-fog agent, an antioxidant, a heat stabilizer; a filler, a radiation stabilizer, an anti-blocking agent or a combination thereof.

10. The film according to claim 9, wherein at least one of the layers comprises from 0.1 to 10% of an anti-skid additive, which anti-skid additive has a particle size between 50 and 500 microns and does not melt or has a melt temperature greater than 500° F.

11. The film according to claim 10, wherein the anti-skid additive is sand, clay, silica, cross-linked polyethylene, ultra high molecular weight polyethylene (UHMWPE) or other polymers.

12. A method for manufacturing a non-porous, pigmented thermoplastic polyolefin film comprising providing a composition for at least one layer of said pigmented film, which composition comprises from about 0.5% to about 30% by weight of a mineral filler agent.

13. The method according to claim 12, wherein said composition comprises from about 0.5% to about 15% by weight of a mineral filler agent.

14. The method according to claim 12, wherein said mineral filler agent has an average or median particle size of about 0.01 microns to about 100 microns.

15. The method according to claim 12, wherein said composition comprises an ethylene-vinyl acetate (EVA) copolymer, a polyolefin plastomer (POP), a high density polyethylene, a medium density polyethylene, a linear low density polyethylene (LLDPE), a low density polyethylene (LDPE) or a combination thereof.

16. The method according to claim 12, wherein the mineral filler agent is calcium carbonate, calcium sulfate, talc, wollastonite, silica, clay, glass fibre or a combination thereof.

17. The method according to claim 16, wherein the mineral filler agent is calcium carbonate.

18. The method according to claim 17, wherein the film comprises a white pigmented layer.

19. The method according to claim 12, wherein the film is elastomeric.

20. The method according to claim 12, wherein at least one of the layers of said film comprises an anti-skid additive, an anti-static agent, an anti-fog agent, an antioxidant, a heat stabilizer; a filler, a radiation stabilizer, an anti-blocking agent or a combination thereof.

21. The method according to claim 12, additionally comprising the step of extruding said composition.
